(19) United States
(12) Patent Application Publication
(10) Pub. No.: US 2007/0094523 A1
(43) Pub. Date: Apr. 26, 2007

(54) Portable storage device having a timer and application information displaying function and a method thereof

(76) Inventor: Hsiang-An Hsieh, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/340,659

(22) Filed: Jan. 27, 2006

(30) Foreign Application Priority Data
Oct. 21, 2005 (TW) 94136941

(51) Int. Cl. G06F 1/00

(52) U.S. Cl. 713/300

(57) ABSTRACT

The portable storage device having a timer and application information displaying function includes a storage unit and a timer display unit. The storage unit includes a storage control unit for analyzing volume information of the storage medium. The timer display unit includes an independent power source for providing power to the timer display unit. A timer display control unit is electrically connected with a communication interface for receiving the volume information of the storage medium and storing it in a volume information storage unit. A timer module used for clocking present time. A display module used for displaying present time clocked by the timer module or the volume information of the storage medium. An operation interface used for operating the timer module and setting the display module.

### BACKGROUND OF THE INVENTION

1. Field of the Invention

The present invention relates to a portable storage device having an information displaying function. In particular, this invention relates to a portable storage device having a timer and application information displaying function and a method thereof.

2. Description of the Related Art

Due to the technology developments of portable storage devices, portable storage device have the characteristics of increasing storage capacity and decreasing volume. Moreover, portable storage devices have excellent appearance and are convenient for users to carry around with them to the extent that portable storage devices have become a fashion accessory as well as an information-carrying product.

Generally, portable storage devices have a display device for displaying the volume information. However, in order to display information on the display device, the portable storage device has to have a built-in independent power source with a capacity large enough to turn on the control unit of the display device. If the portable storage device does not have a large independent power source installed, a bi-state display device is installed to the portable storage device to display the volume information. Thereby, even though the portable storage device is separated from the host application system, such as when the portable storage device is off-line, or the power of the portable storage device is turned off, the portable storage device still can display the volume information for the user.

Portable storage devices usually draw their power supply from the host application system. If the portable storage device is separated from the host application system, the device utilizes one of two methods to enable it to continue displaying information on the display unit. Firstly, it can draw power from an independent power source (such as a battery). The independent power source must have a large capacity. Alternatively, the display unit can adopt a bi-state display device to reduce power consumption. Both methods increase the cost of the product. Installing an independent power source with a lager capacity greatly affects the aesthetic appearance and the weight of the portable storage device. There is also the problem of charging/discharging. At the same time, the display device installed to the portable storage device does not have other functions except for displaying the volume information, such as the indicating present time.

### SUMMARY OF THE INVENTION

One particular aspect of the present invention is to provide a portable storage device having a timer and application information displaying function. The present invention utilizes a low cost timer display unit to indicate present time and display the volume information on the portable storage device. When the portable storage device is separated from a host application system, it only needs an independent power source with a small capacity to provide power to the timer display unit. The present invention also utilizes a button to toggle indication of the present time as clocked by the timer display unit and the volume information of the portable storage device programmed onto the timer display unit. The present invention substantially reduces the cost of the portable storage device and may also replaces regular time-keeping device, such as a watch or a clock, to enhance the value of the product.

The portable storage device having a timer and application information displaying function of the present invention includes a storage unit and a timer display unit. The storage unit includes a storage control unit electrically connected to a storage medium. The storage control unit is used for analyzing the volume information of the storage medium. The timer display unit includes an independent power source for providing power to the timer display unit. A communication interface is electrically connected with the storage control unit. A timer display control unit is electrically connected with the communication interface for receiving volume information of the storage medium and storing it in a volume information storage unit. A timer module is electrically connected with the timer display control unit for present time keeping. A display module is electrically connected with the timer display control unit for displaying the present time kept by the timer module or the volume information of the portable storage device. An operation interface is electrically connected with the timer display control unit for operating the timer module and setting the display module.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a block diagram of the portable storage device having a timer and application information displaying function of the present invention;

FIG. 2 is a flow chart of operating the portable storage device having a timer and application information displaying function of the present invention;

FIG. 2A is a flow chart of operating the display switch or setting the time;

FIG. 3A is a schematic diagram of a preferred embodiment of displaying the time of the present invention; and

FIG. 3B is a schematic diagram of a preferred embodiment of displaying the volume of the present invention.

### DETAILED DESCRIPTION OF THE PREFERRED EMBODIMENTS

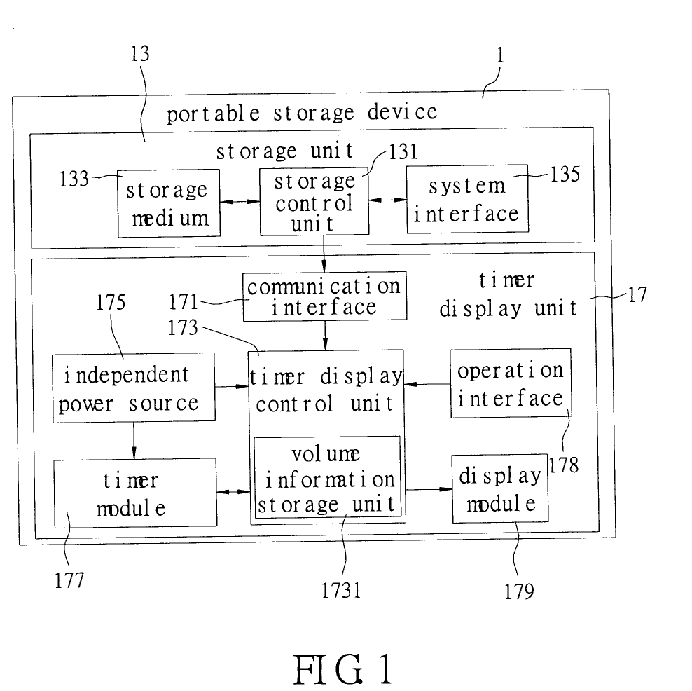

Please refer to FIG. 1, which shows a block diagram of the portable storage device having a timer and application information displaying function of the present invention. In the portable storage device 1 there is a storage unit 13 connected with a timer display unit 17. The storage control unit 131 of the storage unit 13 is connected with a storage medium 133, a system interface 135 and a timer display unit 17. The portable storage device 1 is linked with a host application system (such as a computer) via the system interface 135 and accesses the data in the storage medium 133. After the data is accessed, the storage control unit 131 analyzes the storage medium 133 to generate the volume information of the portable storage device 1. Then, the volume information of the portable storage device 1 is transmitted to the timer display unit 17 via the communication interface 171 and the volume information is stored in a volume information storage unit 1731 of the timer display control unit 173. The storage control unit 131 is electrically connected with the communication interface 171 via a bus or directly electrically connected with the communication interface 171 for transmitting the volume information of the portable storage device 1 to the timer display unit. The volume information may includes capacity of the storage medium, file information and volume label.

Power for the timer display unit 17 is provided by an independent power source 175. The independent power source 175 can drive the timer display control unit 173 to operate and provide power to the timer module 177 for continuously keeping the present time. The independent power source 175 may be a battery. Therefore, when the portable storage device 1 is separated from a host application system (not shown in the figure) and the storage unit 13 cannot work due to a lack of supplied power, the timer display control unit 173 can still work because power is supplied by the independent power source 175. The timer display control unit 173 transmits the present time kept by the timer module 177 to the display module 197 for displaying the present time, and the timer display control unit 173 also reads the volume information of the portable storage device 1 in the volume information storage unit 1731 and displays the volume information on the display module 179. The switch operation of the above two display modes (the present time kept by the timer module 177 and the volume information of the portable storage device 1) can be operated by the user via the operation interface 178. Not only is the operation interface 178 used for switching the display mode, the operation interface 178 can also be used for setting the present time to be kept by the timer module 177 via the timer display control unit 173. Therefore, the user can adjust the daily time on the portable storage device 1 and display the exact time on the display module 179. The operation interface 178 can be a button. The present invention has the function of switching the display modes, and the display module can also be designed to display the daily time of the application information of the storage device for the user.

Therefore, when the portable storage device having a timer and application information displaying function of the present invention is not linked with the host application system, the independent power source 175 provides power to the timer display unit 17 so that it can continue its work. The present time or the volume information of the portable storage device 1 is displayed on the display module 179 and the two display modes are switched via the operation interface 178.

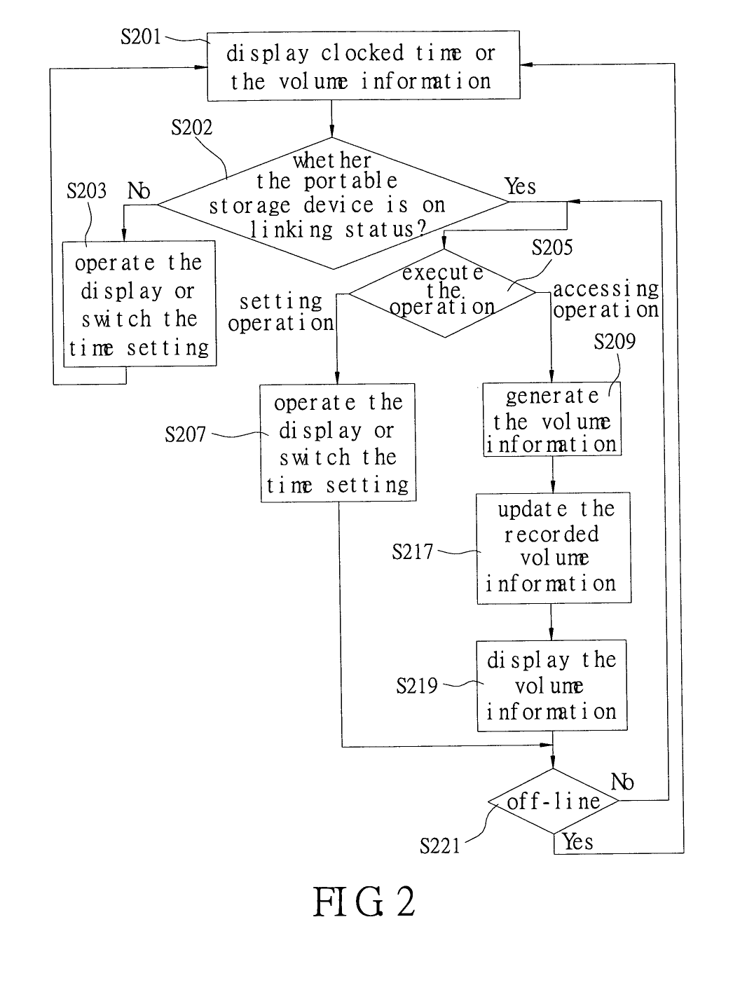

Please refer to FIG. 2, which shows a flow chart of operating the portable storage device having a timer and application information displaying function of the present invention. Firstly, the display module of the portable storage device displays the present time as provided by the timer module, or the volume information of the portable storage device (Step S201 in FIG. 2). Then, whether or not the portable storage device is linked with a host application system is determined (Step S202 in FIG. 2). If the portable storage device is not linked with a host application system, an operation interface is utilized to switch the display modes of the display module or set the present time of the timer module (Step S203 in FIG. 2). The step S203 is explained in more detailed by FIG. 2A, which shows a flow chart of operating the display switch or setting the time.

Please refer to FIGS. 2 and 2A. When the portable storage device is separated from the host application system, the timer module can continuously clocking the present time and the display module can still display the present time as provided by the timer module or the volume information of the portable storage device because there is an independent power source in the timer display unit for providing power. At this time, either the present time is set or the display modes are switched (Step S210 in FIG. 2A). If no operation is selected, the present time as provided by the timer module or the volume information of the portable storage device is displayed on the display module (Step S201 in FIG. 2). If the setting the present time operation is selected, the operation interface adjusts and sets the present time as provided by the timer module and display the set present time on the display module (Step S211 in FIG. 2A), then the process returns to step S201. If the display module displays the volume information of the portable storage device, the operation interface switches the display mode to display the counted time as provided by the timer module (Step S213 in FIG. 2A), then the process returns to step S201. If the display module displays the counted time as provided by the timer module, the operation interface switches the display mode to display the volume information of the portable storage device (Step S215 in FIG. 2A), then the process returns to step S201.

Please refer to FIG. 2 again, which shows the flow chart of operating the portable storage device having a timer and application information displaying function of the present invention. If the portable storage device is linked with a host application system via the system interface, the timer display unit detects the linking status and automatically updates the volume information of the portable storage device displayed on the display module. Next, the operation of the portable storage device is determined (Step S205 in FIG. 2). If the setting operation is executed, the operation interface switches the display modes of the display module or sets the present time as provided by the timer module (Step S207 in FIG. 2). Step S207 is explained in more detailed in FIG. 2A, which shows a flow chart of operating the display switch or setting the time.

Please refer to FIGS. 2 and 2A. Although the portable storage device is linked with the host application system, the timer display unit is still powered by the independent power source and works continuously to keep clocking the present time by the timer module and the display module can still display the present time as provided by the timer module or the volume information of the portable storage device. At this time, either the present time is set or the display modes are switched (Step S210 in FIG. 2A). If no operation is selected, the volume information of the portable storage device is still displayed on the display module, and whether or not the portable storage device is separated from the host application system is determined (Step S221 in FIG. 2). If the setting the present time operation is selected, the operation interface adjusts and sets the present time as provided by the timer module and displays and continuously clocking the set present time on the display module (Step S211 in FIG. 2A), then step S221 is executed. If the display module displays the volume information of the portable storage device, the operation interface switches the display mode to display the present time as provided by the timer module (Step S213 in FIG. 2A), then step S221 is executed. If the display module displays the present time as provided by the timer module, the operation interface switches the display mode to display the volume information of the portable storage device (Step S215 in FIG. 2A), then step S221 is executed.

Please refer to FIG. 2 again, which shows the flow chart of operating the portable storage device having a timer and application information displaying function of the present invention. If the portable storage device executes an access operation, the host application system accesses the storage medium via the system interface. After the host application system accesses the storage medium, the storage control unit analyzes the volume of the storage medium and generates the volume information (Step S209 in FIG. 2). Then, the storage control unit transmits the volume information to the timer display unit via the communication interface and updates the information recorded in the volume information storage unit by the timer display control unit (Step S217 in FIG. 2). The timer display control unit reads the volume information from the volume information storage unit and displays the volume information on the display module (Step S219 in FIG. 2). Finally, whether or not the portable storage device is separated from the host application system is determined (Step S221 in FIG. 2). If the portable storage device is separated from the host application system, step S201 is executed. If the portable storage device is not separated from the host application system, step S205 is executed.

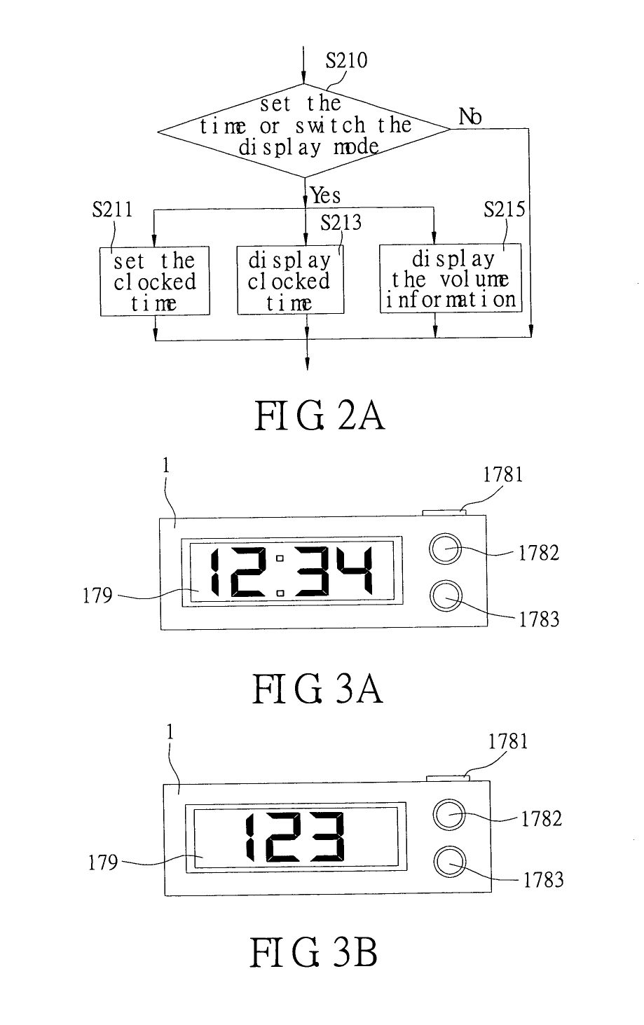

Please refer to FIG. 3A, which shows a schematic diagram of a preferred embodiment of displaying the time of the present invention. The user can view the present time indicated on the display module 179 of the portable storage device 1 and execute the setting/confirming operation by utilizing the setting/confirming button 1782 and thereby adjust the time via the adjusting button 1783. For example, firstly the setting/confirming button 1782 is pressed to request the setting-time operation. Then, the adjusting button 1783 is pressed to adjust the hour of the time and the setting/confirming button 1782 is pressed to confirm the hour of the time. Then, the adjusting button 1783 is pressed again to adjust the minute of the time and the setting/confirming button 1782 is pressed to confirm the minute of the time. Alternatively, the user can utilize the switching button 1781 to switch the display modes. When the switching button 1781 is pressed, the user changes the display mode from the time display mode to the volume information of the portable storage device display mode, as shown in the FIG. 3B, which shows a schematic diagram of a preferred embodiment of displaying the volume of the present invention.

The portable storage device having a timer and application information displaying function of the present invention can display the volume or label information of the storage device, and it also has the function of clocking present time to replace regular time keeping devices, such as watches or clocks. It also does not have the drawbacks of prior art portable storage devices capable of displaying the volume information, such as installing a costly bi-state display module, or installing a costly and large capacity independent power source.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A portable storage device having a timer and application information displaying function, comprising:
a storage unit for storing data and generating a volume information; and
a timer display unit, comprising:
an independent power source for providing power to the timer display unit;
a communication interface electrically connected with the storage control unit for receiving the volume information;
a timer display control unit electrically connected with the communication interface and having a volume information storage unit; wherein the volume information is stored in the volume information storage unit;
a timer module electrically connected with the timer display control unit for clocking time;
a display module electrically connected with the timer display control unit for displaying the time clocked by the timer module or the volume information of the portable storage device; and
an operation interface electrically connected with the timer display control unit for operating the timer module and setting the display module.

2. The portable storage device having a timer and application information displaying function as claimed in claim 1, wherein the storage unit further comprises:
a storage medium for storing the data;
a system interface linked with an external application system; thereby, the host application system reads, writes or accesses the storage medium via the system interface; and
a storage control unit electrically connected with the storage medium, the system interface and the communication interface, used for analyzing the storage medium to generate the volume information and transmit the volume information to the communication interface.

3. The portable storage device having a timer and application information displaying function as claimed in claim 1, wherein the independent power source is a battery.

4. The portable storage device having a timer and application information displaying function as claimed in claim 1, wherein the timer display control unit is driven by the independent power source.

5. The portable storage device having a timer and application information displaying function as claimed in claim 1, wherein the independent power source provides power to the timer module.

6. The portable storage device having a timer and application information displaying function as claimed in claim 5, wherein the timer display control unit obtains the clocked time from the timer module, and updates and continuously displays the clocked time on the display module.

7. The portable storage device having a timer and application information displaying function as claimed in claim 1, wherein the timer display control unit obtains the volume information time from the volume information storage unit, and displays the volume information on the display module.

8. The portable storage device having a timer and application information displaying function as claimed in claim 1, wherein the operation interface sets the time on the timer module via the timer display control unit for clocking the standard time.

9. The portable storage device having a timer and application information displaying function as claimed in claim 1, wherein the display module executes the switch of displaying the clocked time as provided by the timer module and the displaying the volume information of the storage medium via the operation interface.

10. The portable storage device having a timer and application information displaying function as claimed in claim 1, wherein the communication interface is electrically connected with the storage unit via a bus.

11. The portable storage device having a timer and application information displaying function as claimed in claim 1, wherein the operation interface is a button interface.

12. A method for displaying the timer and application information of a portable storage device, the portable storage device is linked with a host application system, the steps comprising:
providing an independent power source in the portable storage device for providing power to a timer display unit;
displaying a volume information or a clocked time on the display module of the timer display unit;
switching to display the information on the display module or set the clocked time;
analyzing a storage medium of the portable storage device to generate the volume information via a storage control unit, after the host application system accesses the portable storage device;
storing the volume information generated by the storage control unit onto a volume information storage unit; and
reading the volume information and displaying the volume information on the display module.

13. The method for displaying the timer and application information of a portable storage device as claimed in claim 12, wherein the timer display detects the linking status to automatically update and display the volume information of the portable storage device on the display module, when the portable storage device is linked with the host application system.

14. The method for displaying the timer and application information of a portable storage device as claimed in claim 12, wherein the step of switching to display the information on the display module or set the clocked time further comprises:
utilizing an operation interface to set the clocked time via a timer display control unit; and
utilizing the operation interface to switch the display of the clocked time and the volume information via the timer display control unit.

15. The method for displaying the timer and application information of a portable storage device as claimed in claim 14, wherein the timer display control unit is powered by the independent power source.

16. The method for displaying the timer and application information of a portable storage device as claimed in claim 14, wherein the timer display control unit obtains the volume information from the volume information storage unit, and displays the volume information on the display module.

17. The method for displaying the timer and application information of a portable storage device as claimed in claim 14, wherein the timer display control unit reads the clocked time from the timer module, and displays the clocked time on the display module.

18. The method for displaying the timer and application information of a portable storage device as claimed in claim 12, wherein the independent power source provides power to the timer module for clocking the time.

19. The method for displaying the timer and application information of a portable storage device as claimed in claim 12, wherein the volume information is read by a timer display control unit of the timer display unit from the volume information storage unit and displayed on the display module, and the timer display control unit is powered by the independent power source.

20. The method for displaying the timer and application information of a portable storage device as claimed in claim 12, wherein the volume information generated by the storage control unit is transmitted to the volume information storage unit via a communication interface.

21. A method for displaying the timer and application information of a portable storage device, the portable storage device being on an off-line status, the steps comprising:
providing an independent power source to the portable storage device for providing power to a timer display unit;
providing power to a timer module via the independent power source for outputting a clocked time;
driving a timer display control unit via the independent power source to display a volume information of portable storage device or the clocked time clocked by timer module on a display module;
switching the display of the clocked time or the volume information on the display module via an operation interface; and
setting the clocked time of the timer module via the operation interface.

22. The method for displaying the timer and application information of a portable storage device as claimed in claim 21, wherein the operation interface sets the clocked time of the timer module via the timer display control unit.

23. The method for displaying the timer and application information of a portable storage device as claimed in claim 21, wherein the volume information is obtained via a storage device controller that analyzes a storage medium and is stored into a volume information storage unit.

24. The method for displaying the timer and application information of a portable storage device as claimed in claim 23, wherein the volume information is stored in the volume information storage unit via a communication interface.

25. The method for displaying the timer and application information displaying of a portable storage device as claimed in claim 21, wherein the volume information is read by the timer display control unit from the volume information storage unit and is displayed on the display module.
